(19) United States
(12) Patent Application Publication
(10) Pub. No.: US 2024/0192245 A1
(43) Pub. Date: Jun. 13, 2024

(54) AUTOMATIC ANALYSIS DEVICE AND ABNORMALITY DETECTION METHOD

(71) Applicant: CANON MEDICAL SYSTEMS CORPORATION, Otawara-shi (JP)

(72) Inventors: Takahiro OMORI, Otawara (JP); Hideto KOJIMA, Nikko (JP); Takafumi FUJIWARA, Nasushiobara (JP); Takeshi KINPARA, Utsunomiya (JP); Yoshifumi YAMAGATA, Sakura (JP); Tomoaki KURANO, Nasushiobara (JP)

(73) Assignee: CANON MEDICAL SYSTEMS CORPORATION, Otawara-shi (JP)

(21) Appl. No.: 18/517,051

(22) Filed: Nov. 22, 2023

(30) Foreign Application Priority Data
Dec. 12, 2022 (JP) 2022-197884

(51) Int. Cl. G01N 35/10; G01N 35/00

(52) U.S. Cl. CPC G01N 35/1009; G01N 35/00623; G01N 2035/1025

(57) ABSTRACT

An automatic analysis device according to the present embodiment includes a processor. The processor calculates the liquid level height in a reaction tube, based on a scheduled dispensing amount of liquid to be dispensed into the reaction tube. The processor detects whether there is an abnormality in a dispensing operation in which liquid is dispensed into the reaction tube, based on a measured liquid level height in the reaction tube and a calculated liquid level height in the reaction tube.

### CROSS-REFERENCE TO RELATED APPLICATIONS

This application is based upon and claims the benefit of priority from Japanese Patent Application No. 2022-197884, filed on Dec. 12, 2022; the entire contents of which are incorporated herein by reference.

### FIELD

Embodiments described herein relate generally to an automatic analysis device and an abnormality detection method.

### BACKGROUND

An automatic analysis device dispenses a standard sample of test items or a sample to be tested collected from a subject (hereinafter, simply referred to as a sample) into a reaction tube, dispenses reagent in a reagent bottle stored in a reagent storage into the reaction tube, and measures the mixture of the sample and reagent in the reaction tube. Moreover, when a sample or a reagent is dispensed, a pressure gauge is installed in a flow path between a probe that aspirates a sample or reagent and a dispensing syringe, to detect clogging in the probe caused by the aspiration of solid foreign bodies and the like, and to detect a suction abnormality due to air bubbles and the like.

However, with a configuration using a pressure gauge to detect the pressure, although it is possible to detect whether an appropriate amount of sample or reagent is aspirated, it is not possible to determine whether the sample or reagent is discharged. For example, when a sample or reagent is dispensed into a reaction tube, splattering of the sample or reagent in the reaction tube may cause the sample or reagent to adhere to the inner wall of the reaction tube. In this case, because the amount of sample or reagent is not enough, the reaction between the sample and reagent may become insufficient and may affect the analysis accuracy. Hence, there is room for further improvement.

### BRIEF DESCRIPTION OF THE DRAWINGS

FIG. 1 is a block diagram illustrating an example of a configuration of an automatic analysis device according to an embodiment;

FIG. 2 is a perspective view illustrating an example of a configuration of an analysis device according to the embodiment;

FIG. 3 is a schematic diagram illustrating an example when the automatic analysis device according to the embodiment detects an abnormality in a dispensing operation; and

FIG. 4 is a flowchart illustrating an example of processing contents of the automatic analysis device according to the embodiment.

### DETAILED DESCRIPTION

Hereinafter, an automatic analysis device according to the present embodiment will be described with reference to the accompanying drawings. In the following embodiments, parts denoted by the same reference numerals are assumed to perform the same operation, and overlapping descriptions are omitted as appropriate.

### Embodiment

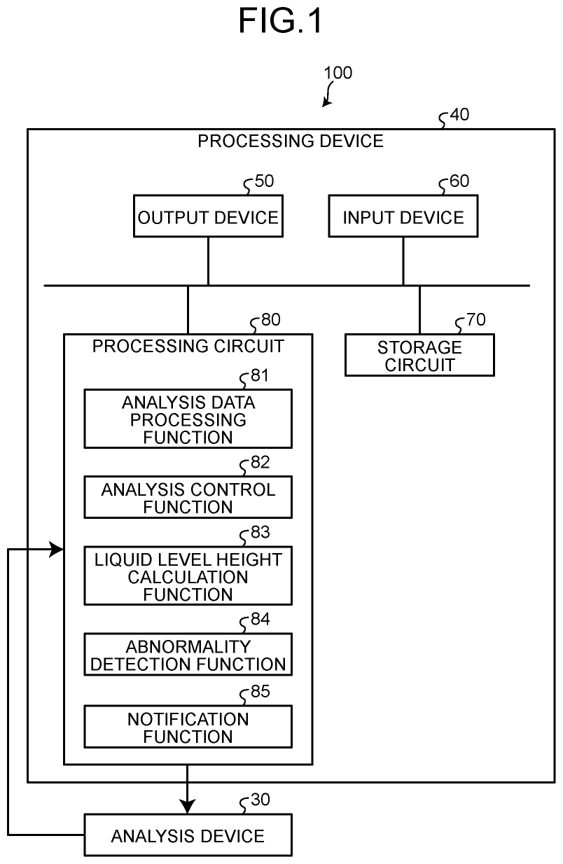

FIG. 1 is a block diagram illustrating an example of a configuration of an automatic analysis device 100 according to an embodiment. The automatic analysis device 100 includes an analysis device 30 and a processing device 40. The configuration illustrated in FIG. 1 is merely an example, and the configuration of the automatic analysis device 100 is not limited thereto.

The analysis device 30 is a device that dispenses a standard sample of test items or a sample to be tested collected from a subject (hereinafter, simply referred to as a sample) into a reaction tube, dispenses reagent in a reagent bottle stored in a reagent storage into the reaction tube, and measures the mixture of the sample and reagent in the reaction tube.

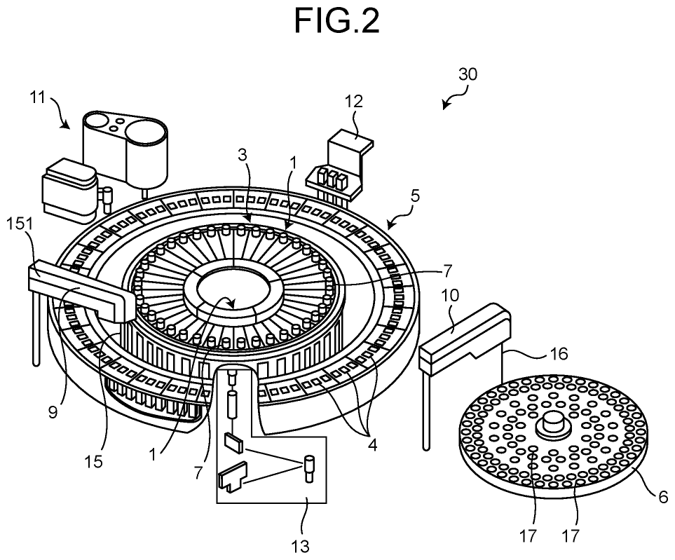

In this example, the configuration of the analysis device 30 will be described with reference to FIG. 2. FIG. 2 is a perspective view of the analysis device 30 according to the present embodiment. The analysis device 30 includes a reagent container 7 containing a reagent that selectively reacts to a sample item or the diluent of the item, a reagent rack 1 that houses the reagent container 7, a reagent storage 3 that houses the reagent rack 1 for housing the reagent container 7 that contains a reagent, a reaction disk 5 in which a plurality of reaction tubes 4 are disposed on the circumference, and a disk sampler 6 in which a sample container 17 for housing the sample and the diluent is being set. In the analysis device 30, for each cycle, each of the reagent storage 3 and the disk sampler 6 turns, the reaction disk 5 rotates, and stops at a position controlled by an analysis control function 82 of a processing circuit 80.

Next, probes will be described. The analysis device 30 of the present embodiment include a reagent dispensing probe 15 and a sample dispensing probe 16. In the following, the term “probe” collectively refers to the two types of probes. For each cycle, the reagent dispensing probe 15 aspirates reagent from the reagent container 7 at a reagent aspirating position of the reagent storage 3, and then dispenses the aspirated reagent into the reaction tube 4 that has stopped at a reagent dispensing position. Moreover, the reagent dispensing probe 15 includes a reagent dispensing arm 9 that holds the reagent dispensing probe 15 in a rotatable and vertically movable manner.

Furthermore, the reagent dispensing probe 15 includes a detector 151 that detects the liquid level in the reaction tube 4 into which the sample and reagent have been dispensed. Specifically, the detector 151 is electrically connected to the reagent dispensing probe 15, and is provided on the reagent dispensing probe 15. The detector 151 detects the liquid level in the reaction tube, by a change in the electrostatic capacitance, when the detector 151 comes close to or comes into contact with the liquid level in the reaction tube. The detector 151 outputs the detected results (the measured liquid level height in the reaction tube) to the processing circuit 80.

After aspirating a sample or diluent from the sample container 17 in the disk sampler 6 at a location controlled by the analysis control function 82 of the processing circuit 80, the sample dispensing probe 16 dispenses the sample or diluent into the reaction tube 4 that has stopped at a sample dispensing position. The sample dispensing probe 16 includes a sample dispensing arm 10 that holds the sample dispensing probe 16 in a rotatable and vertically movable manner.

Moreover, the analysis device 30 includes a stirring unit 11 that stirs the mixture of the sample and reagent, the mixture of the diluent and reagent, or the like in the reaction tube 4 that has stopped at a stirring position for each cycle, a photometric unit 13 that measures the reaction tube 4 containing the mixture from a photometric position, and a cleaning unit 12 that aspirates the mixture the measurement of which is finished in the reaction tube 4 having stopped at a cleaning and drying position, and that cleans and dries the inside of the reaction tube 4.

The photometric unit 13 measures a change in the absorbance of the mixture by irradiating the reaction tube 4 that rotatably moves with light from the photometric position, and outputs an analysis signal or a calibration signal of the sample or diluent obtained from the measurement, to an analysis data processing function 81 of the processing circuit 80. Then, the reaction tube 4 that is cleaned and dried after the measurement of the mixture is finished, is used for measurement again.

The analysis device 30 includes mechanisms for turning each of the reagent storage 3 and the disk sampler 6, rotating the reaction disk 5, turning and vertically moving each of the reagent dispensing arm 9, the sample dispensing arm 10, and the stirring unit 11, vertically moving the cleaning unit 12, and the like. Moreover, the analysis device 30 includes various pumps such as a dispensing pump for aspirating and discharging the sample or diluent from the sample dispensing probe 16, a reagent pump for aspirating and discharging the reagent from the reagent dispensing probe 15, a cleaning pump for supplying and aspirating the cleaning liquid for cleaning inside the reaction tube 4 from the cleaning unit 12, a drying pump for drying the inside of the reaction tube 4, and the like. Furthermore, the analysis device 30 includes a mechanism for driving the stirring unit 11 to stir.

Returning to FIG. 1. The processing device 40 includes an output device 50, an input device 60, a storage circuit 70, and the processing circuit 80. The configuration of the processing device 40 is not limited thereto.

The output device 50 is connected to the processing circuit 80, and prints out a calibration table, analysis data, or the like output from the analysis data processing function 81 of the processing circuit 80, which will be described below. The output device 50 is an example of an output unit. For example, the output device 50 includes a printer or the like, and prints out the calibration table, the analysis data, or the like output from the analysis data processing function 81 of the processing circuit 80 on a printer sheet, on the basis of a preset format.

Moreover, the output device 50 outputs the calibration table, the analysis data, or the like output from the analysis data processing function 81 of the processing circuit 80. For example, the output device 50 includes a display such as a CRT and a liquid crystal panel, and outputs the calibration table, the analysis data, or the like output from the analysis data processing function 81 of the processing circuit 80. Moreover, the output device 50 outputs a screen for setting analysis conditions instructed by the analysis control function 82 of the processing circuit 80.

Furthermore, the output device 50 outputs the abnormality in the reaction tube 4 notified by a notification function 85 of the processing circuit 80. Still furthermore, the output device 50 externally outputs (outputs online) the analysis data or the like to an external information system (not illustrated) or the like via a network. The output device 50 causes the storage circuit 70 to store the display output results that are displayed and output, and the external outputs that are output externally.

The input device 60 is a device connected to the processing circuit 80, and with which the user performs an input operation. The input device 60 is an example of an input unit. For example, the input device 60 is a device such as a keyboard, a mouse, a button, and a touch keypad panel. The user uses the input device 60 to perform various operations such as setting analysis conditions, inputting subject information such as the subject ID of the subject and the subject name, selecting the measurement items for each sample of the subject, calibration operation on each item, sample analysis operation, and the like. The input device 60 causes the storage circuit 70 to store the input results.

The storage circuit 70 is connected to the processing circuit 80, and stores various types of data. The storage circuit 70 is an example of a storage unit. For example, the storage circuit 70 is implemented by a semiconductor memory element such as a Random Access Memory (RAM) and a flash memory, a hard disk, an optical disc, or the like. The storage circuit 70 stores the calibration table, the analysis data, or the like output from the analysis data processing function 81 of the processing circuit 80, for each sample. Moreover, the storage circuit 70 stores the analysis conditions instructed by the analysis control function 82 of the processing circuit 80.

Furthermore, the storage circuit 70 stores the theoretical liquid level height calculated by a liquid level height calculation function 83 of the processing circuit 80, and the actual liquid level height. The storage circuit 70 stores the results detected by an abnormality detection function 84 of the processing circuit 80. Moreover, the storage circuit 70 stores the abnormality in the reaction tube 4, that is notified by the notification function 85 of the processing circuit 80. Furthermore, the storage circuit 70 stores various computer programs for implementing various functions that are read and executed by the processing circuit 80.

The processing circuit 80 controls the entire operation of the analysis device 30 and the processing device 40. For example, the processing circuit 80 includes the analysis data processing function 81, the analysis control function 82, the liquid level height calculation function 83, the abnormality detection function 84, and the notification function 85. In the embodiment, the processing functions performed by the analysis data processing function 81, the analysis control function 82, the liquid level height calculation function 83, the abnormality detection function 84, and the notification function 85 are stored in the storage circuit 70 in the form of computer executable programs.

The processing circuit 80 is a processor that reads a computer program from the storage circuit 70, and that implements the function corresponding to each computer program by executing the computer program. In other words, the processing circuit 80 that has read out each computer program will have each of the functions illustrated in the processing circuit 80 in FIG. 1.

In FIG. 1, the analysis data processing function 81, the analysis control function 82, the liquid level height calculation function 83, the abnormality detection function 84, and the notification function 85 are implemented by a single processor. However, it is not limited thereto, and the processing circuit 80 may be configured by combining a plurality of independent processors, and the function may be implemented by each processor executing a computer program.

Moreover, in FIG. 1, a single storage circuit such as the storage circuit 70 stores a computer program corresponding to each processing function. However, it is not limited thereto, and a plurality of storage circuits may be disposed in a distributed manner, and the processing circuit 80 may read out a corresponding computer program from individual storage circuits.

For example, the term “processor” used in the above description refers to a circuit such as a Central Processing Unit (CPU), a Graphical Processing Unit (GPU), an Application Specific Integrated Circuit (ASIC), or a programmable logic device (for example, a Simple Programmable Logic Device (SPLD), a Complex Programmable Logic Device (CPLD), and a Field Programmable Gate Array (FPGA)).

The processor implements functions by reading and executing a computer program stored in the storage circuit 70. Instead of storing a computer program in the storage circuit 70, the computer program may also be directly incorporated into the circuit of the processor. In this case, the processor implements the function by reading and executing the computer program incorporated in the circuit.

The analysis data processing function 81 creates a calibration table from the calibration signals, the analysis signals, and the like output from the analysis device 30, calculates the analysis data, and the like. The analysis data processing function 81 is an example of an analysis data processing unit. For example, the analysis data processing function 81 creates a calibration table for each item from the calibration signal for each item output from the analysis device 30, and outputs the created calibration table to the output device 50.

Moreover, with respect to the analysis signal for each item output from the analysis device 30, after reading the calibration table corresponding to the item of the analysis signal from the storage circuit 70, the analysis data processing function 81 calculates the analysis data using the calibration table and outputs the calculated analysis data to the output device 50. Furthermore, the analysis data processing function 81 causes the storage circuit 70 to store the results output to the output device 50.

On the basis of a command signal of the user input by the input device 60, the analysis conditions, the subject information, and the analysis information such as the measurement items of each sample, and the like, the analysis control function 82 controls the entire automatic analysis device 100 including controlling the units that configure the analysis device 30 in a predetermined sequence in a certain cycle, creating a calibration table, controlling the calculation and output of the analysis data, and the like.

The liquid level height calculation function 83 calculates the liquid level height in the reaction tube. The liquid level height calculation function 83 is an example of a liquid level height calculation unit. The liquid level height calculation function 83 calculates the liquid level height in the reaction tube, on the basis of a scheduled dispensing amount of liquid to be dispensed into the reaction tube 4. For example, after the reagent and sample are dispensed into the reaction tube 4 by the probe, the liquid level height calculation function 83 calculates the liquid level height in the reaction tube, on the basis of the scheduled dispensing amount of the sample and reagent to be dispensed into the reaction tube 4 by the probe.

The abnormality detection function 84 detects whether there is an abnormality in the dispensing operation. The abnormality detection function 84 is an example of an abnormality detection unit. The abnormality detection function 84 detects whether there is an abnormality in the dispensing operation in which the sample and reagent are dispensed into the reaction tube 4, on the basis of the measured liquid level height in the reaction tube and the calculated liquid level height in the reaction tube. For example, on the basis of the liquid level height indicating the height of liquid from the bottom surface to the liquid level in the reaction tube into which the sample and reagent have been dispensed that is measured by the detector 151, and the liquid level height from the bottom surface to the liquid level in the reaction tube 4 calculated by the liquid level height calculation function 83, the abnormality detection function 84 determines whether the measured liquid level height matches with the calculated liquid level height.

Moreover, for example, if the measured liquid level height matches with the calculated liquid level height, the abnormality detection function 84 detects that there is no abnormality in the dispensing operation. On the other hand, if the measured liquid level height does not match with the calculated liquid level height, the abnormality detection function 84 detects an abnormality in the dispensing operation. Moreover, the abnormality detection function 84 causes the storage circuit 70 to store the detected detection results.

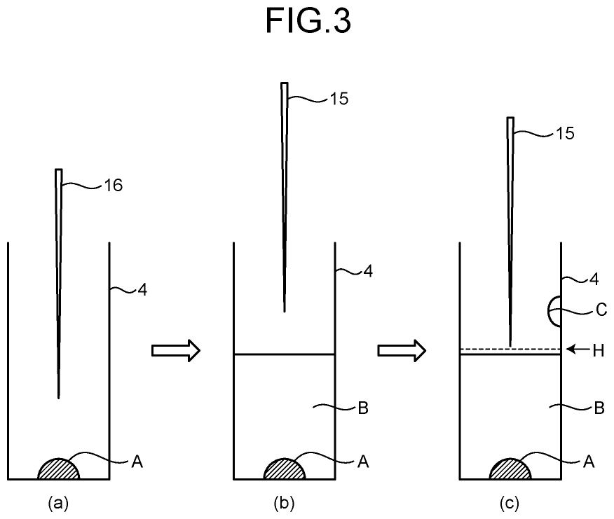

In this example, with reference to FIG. 3, a state in which abnormality is present in the dispensing operation will be described. FIG. 3 is a schematic diagram illustrating an example when the automatic analysis device 100 according to the embodiment detects an abnormality in the dispensing operation. FIG. 3 (a) illustrates a state when the sample dispensing probe 16 dispenses a sample A into the reaction tube 4. FIG. 3 (b) illustrates a state when the reagent dispensing probe 15 dispenses reagent B into the reaction tube 4 into which the sample A has been dispensed. FIG. 3 (c) illustrates a state when the detector 151 provided on the reagent dispensing probe 15 detects the liquid level in the reaction tube 4.

As illustrated in FIG. 3 (c), a splatter C of the reagent B adheres to the inner wall surface of the reaction tube 4. The splatter C is on the inner wall surface of the reaction tube 4 into which the sample A and the reagent B have been dispensed. Therefore, the reagent B in the reaction tube 4 is not enough, and when the measured liquid level height is compared with the calculated liquid level height H, the measured liquid level becomes low. Because the measured liquid level height does not reach the calculated liquid level height H, the reaction between the sample A and the reagent B may become insufficient, and may affect the analysis accuracy. Hence, it is possible to say that there is an abnormality in the dispensing operation.

In FIG. 3, a state in which abnormality is present in the dispensing operation is a state in which the splatter C of the reagent B adheres to the inner wall surface of the reaction tube 4. However, it is not limited thereto. For example, in a case when the reaction tube 4 is cleaned by a cleaning pump using a cleaning liquid, if the inside of the reaction tube 4 is not sufficiently dried even though the inside of the reaction tube 4 is dried by a drying pump, the cleaning liquid may remain inside the reaction tube 4.

When the sample A and the reagent B are dispensed into the reaction tube 4 with the remaining cleaning liquid by the probe, the measured liquid level height becomes higher than the calculated liquid level height. The measured liquid level height exceeds the calculated liquid level height H, and because of the remaining cleaning liquid, the mixture of the sample and reagent is diluted, and the reaction between the sample and the reagent may become insufficient and may affect the analysis accuracy. Hence, it is possible to say that there is an abnormality in the dispensing operation.

Returning to FIG. 1. The notification function 85 notifies an abnormality in the dispensing operation. The notification function 85 is an example of a notification unit. When the abnormality detection function 84 detects an abnormality in the dispensing operation, the notification function 85 notifies the output device 50 of the abnormality in the dispensing operation.

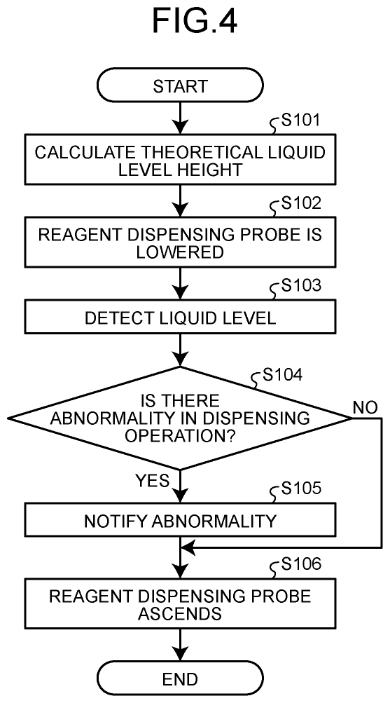

FIG. 4 is a flowchart illustrating an example of processing performed by the automatic analysis device 100. In the following, for more specific description, it is assumed that the flow starts after the reagent and sample are dispensed into the reaction tube 4 by the probe.

The liquid level height calculation function 83 of the processing circuit 80 calculates the liquid level height in the reaction tube, on the basis of the dispensing amount of the reagent and sample dispensed by the probe (step S101). Subsequently, the reagent dispensing probe 15 is lowered into the reaction tube 4 (step S102). Subsequently, the detector 151 provided on the reagent dispensing probe 15 detects the liquid level, by a change in the electrostatic capacitance, when the detector 151 comes close to or comes into contact with the liquid level in the reaction tube (step S103).

The abnormality detection function 84 of the processing circuit 80 detects whether there is an abnormality in the dispensing operation in which the reagent and sample are dispensed into the reaction tube 4, on the basis of the detection results (measured liquid level height) output by the detector 151 provided on the reagent dispensing probe 15, and the calculated liquid level height calculated by the liquid level height calculation function 83. (step S104). In this process, when it is determined that the measured liquid level height matches with the calculated liquid level height, the abnormality detection function 84 of the processing circuit 80 detects that there is no abnormality in the dispensing operation (No at step S104), and the process proceeds to step S106.

On the other hand, when it is determined that the measured liquid level height does not match with the calculated liquid level height, the abnormality detection function 84 of the processing circuit 80 detects an abnormality in the dispensing operation (Yes at step S104), and the process proceeds to step S105. At step S105, the notification function 85 of the processing circuit 80 notifies the output device 50 of the abnormality in the dispensing operation (step S105). Subsequently, the reagent dispensing probe 15 ascends inside the reaction tube 4 (step S106). When the process at step S106 is finished, the present process is terminated. When the present process is terminated, the reaction tube 4 is stirred by the stirring unit 11.

As described above, the automatic analysis device 100 according to the embodiment calculates the liquid level height in the reaction tube on the basis of the scheduled dispensing amount of liquid to be dispensed into the reaction tube 4, and detects whether there is an abnormality in the dispensing operation in which liquid is dispensed into the reaction tube 4, on the basis of the measured liquid level height in the reaction tube and the calculated liquid level height in the reaction tube.

According to at least one of the embodiments described above, for example, when a sample and reagent are dispensed into the reaction tube 4, splattering of the sample or reagent in the reaction tube may cause the sample or reagent to adhere to the inner wall of the reaction tube. Hence, the user can recognize that the amount of sample or reagent is not enough. Consequently, the user can recognize in advance the effects on analysis accuracy of the reaction tube 4 into which the sample and reagent have been dispensed.

### First Modification

In the embodiment described above, the liquid level in the reaction tube into which the sample and reagent have been dispensed is detected, when the detector 151 provided on the reagent dispensing probe 15 for dispensing reagent detects a change in the electrostatic capacitance, when the detector 151 comes close to or comes into contact with the liquid level in the reaction tube into which the sample and reagent have been dispensed. In contrast, in a first modification, the analysis device 30 may include a liquid level height detection probe for detecting the liquid level height, to detect the liquid level in the reaction tube into which the sample and reagent have been dispensed. The liquid level height detection probe detects the liquid level, by a change in the electrostatic capacitance when the liquid level height detection probe comes close to or comes into contact with the liquid level in the reaction tube into which the sample and reagent have been dispensed.

### Second Modification

In the embodiment described above, the liquid level in the reaction tube into which the sample and reagent have been dispensed is detected, when the detector 151 provided on the reagent dispensing probe 15 for dispensing reagent detects a change in the electrostatic capacitance, when the detector 151 comes close to or comes into contact with the liquid level in the reaction tube into which the sample and reagent have been dispensed. In contrast, in a second modification, to dispense diluent, the sample dispensing probe 16 may include a detector for detecting the liquid level height, to detect the liquid level in the reaction tube into which the sample and diluent have been dispensed. The sample dispensing probe 16 detects the liquid level by a change in the electrostatic capacitance when the detector comes close to or comes into contact with the liquid level in the reaction tube into which the sample and diluent have been dispensed.

### Third Modification

In the embodiment described above, the analysis device 30 includes a single reagent dispensing probe 15. In contrast, in a third modification, the analysis device 30 may include a plurality of the reagent dispensing probes 15. For example, if there are two reagent dispensing probes 15 (first reagent and second reagent), the liquid level height in the reaction tube into which the sample, first reagent, and second reagent have been dispensed is detected, after the second reagent is dispensed into the reaction tube 4 into which the sample and first reagent have been dispensed.

That is, in a mode in which a plurality of the reagent dispensing probes 15 are provided, the liquid level in the reaction tube into which the sample and a plurality of reagents have been dispensed is detected, before the mixture is stirred by the stirring unit 11. Consequently, for example, when the sample and reagents are dispensed into the reaction tube 4, and if there is splattering in the reaction tube, the user can recognize in advance the effects on analysis accuracy of the reaction tube 4 into which the sample and reagents have been dispensed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An automatic analysis device, comprising:
a processor, wherein
the processor is configured to
calculate a liquid level height in a reaction tube, based on a scheduled dispensing amount of liquid to be dispensed into the reaction tube, and
detect whether there is an abnormality in a dispensing operation in which liquid is dispensed into the reaction tube, based on a measured liquid level height in the reaction tube and a calculated liquid level height in the reaction tube.

2. The automatic analysis device according to claim 1, wherein the processor detects an abnormality in the dispensing operation, when the measured liquid level height in the reaction tube does not match with the calculated liquid level height in the reaction tube.

3. The automatic analysis device according to claim 1, wherein a liquid level in the reaction tube into which the liquid has been dispensed is detected by a change in an electrostatic capacitance when a detector provided on a reagent dispensing probe for dispensing reagent comes close to or comes into contact with the liquid level in the reaction tube into which the liquid has been dispensed.

4. The automatic analysis device according to claim 2, wherein upon detecting an abnormality in the dispensing operation, the processor notifies the abnormality in the dispensing operation.

5. An abnormality detection method performed by an automatic analysis device, the abnormality detection method, comprising:
calculating a liquid level height in a reaction tube, based on a scheduled dispensing amount of liquid to be dispensed into the reaction tube, and
detecting whether there is an abnormality in a dispensing operation in which liquid is dispensed into the reaction tube, based on a measured liquid level height in the reaction tube and a calculated liquid level height in the reaction tube.
